(19) United States
(12) Patent Application Publication
(10) Pub. No.: US 2012/0155852 A1
(43) Pub. Date: Jun. 21, 2012

(54) CAMERA MODULE WITH HIGH STABILITY

(75) Inventor: SHENG-HUNG HOU, New Taipei (TW)

(73) Assignee: HON HAI PRECISION INDUSTRY CO., LTD., New Taipei (TW)

(21) Appl. No.: 13/177,122

(22) Filed: Jul. 6, 2011

(30) Foreign Application Priority Data
Dec. 17, 2010 (TW) 99144342

(51) Int. Cl. G03B 17/00

(52) U.S. Cl. 396/529

(57) ABSTRACT

A camera module includes a printed circuit board (PCB), an image sensor positioned on the PCB, a lens holder positioned on the PCB and covering the image sensor, a lens barrel coupled to the lens holder, and a lens received in the lens barrel. The lens holder includes an outer sensor cover and an inner sensor cover connected to the outer sensor cover. The outer sensor cover defines a receiving cavity. The image sensor and the inner sensor cover are received in the receiving cavity. The inner sensor cover is fixed to and resists the image sensor, and the distance between the end surface of the outer sensor cover and the PCB is equal to or greater than zero.

### BACKGROUND

1. Technical Field

The present disclosure relates to camera modules and, particularly, to a camera module with high stability.

2. Description of Related Art

Camera modules generally include a printed circuit board (PCB), a lens holder placed on the PCB, an image sensor placed on the PCB and received in the lens holder, a lens barrel held by the lens holder, and a lens received in the lens barrel. The PCB, the lens holder, the lens barrel, and the lens cooperatively define an enclosed cavity, in which the image sensor is received. In operation, the image sensor generates heat, which cannot be efficiently dissipated. As a result, increased temperature inside the enclosed space may cause the PCB to undergo deformation, which in turn may cause the displacement of the lens holder and the image sensor, thereby decreasing the image quality of the camera module.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric, assembled view of an embodiment of a camera module, including a lens holder.

FIG. 2 is an isometric, exploded view of the camera module of FIG. 1.

FIG. 3 is an isometric view of a lens holder of the camera module of FIG. 1.

FIG. 4 is a cross-sectional view of the camera module, taken along a line IV-IV of FIG. 1.

### DETAILED DESCRIPTION

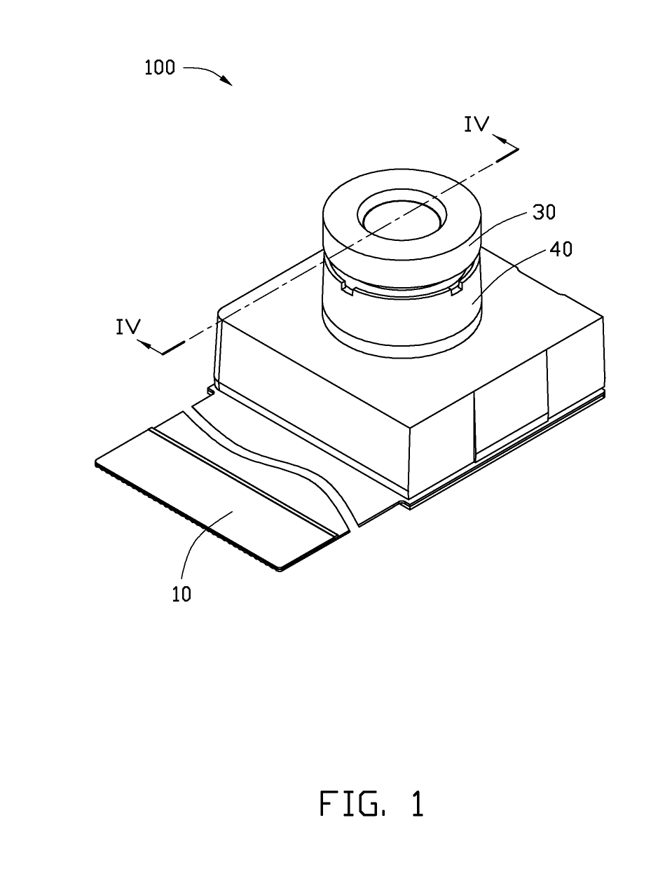

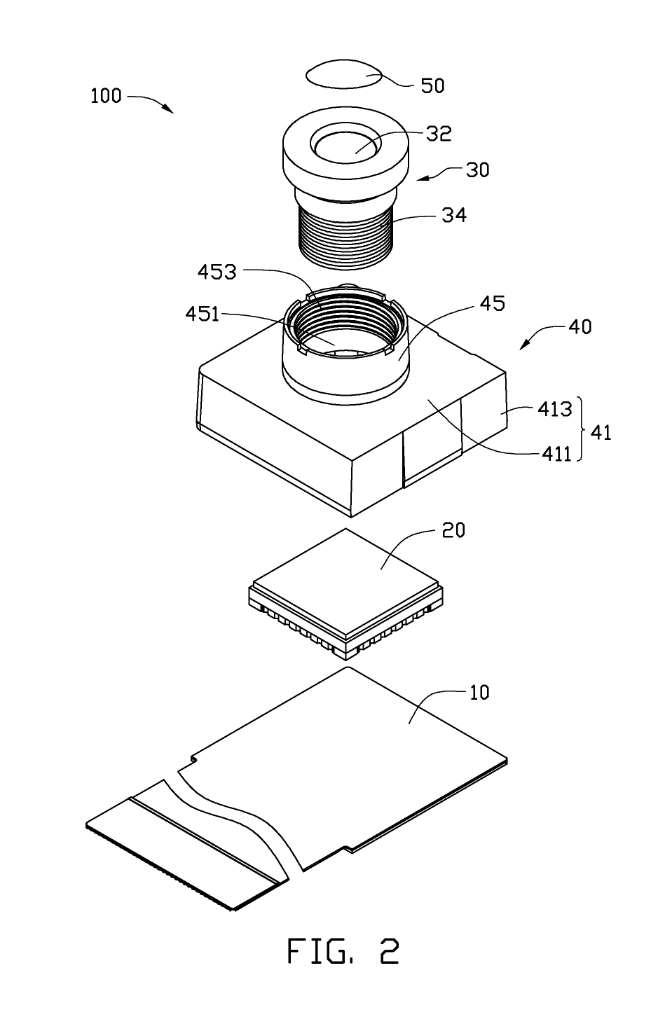

Referring to FIGS. 1 and 2, an embodiment of a camera module 100 includes a printed circuit board (PCB) 10, an image sensor 20, a lens barrel 30, a lens 50, and a lens holder 40. The image sensor 20 is securely placed on the PCB 10. The lens 50 is securely fixed in the lens barrel 30. The lens holder 40 holds the lens barrel 30, and is securely placed on the image sensor 20.

The PCB 10 is a flexible PCB (FPCB) in this embodiment and thus is readily deformed.

The image sensor 20, such as a couple charge-coupled device (CCD) sensor or a complementary metal oxide semiconductor (CMOS) sensor, is configured for capturing images.

The lens barrel 30 is a tube, which defines a barrel hole 32 extending through the lens barrel 30. The lens barrel 30 forms an external threaded section 34 in the outer surface of the lens barrel 30.

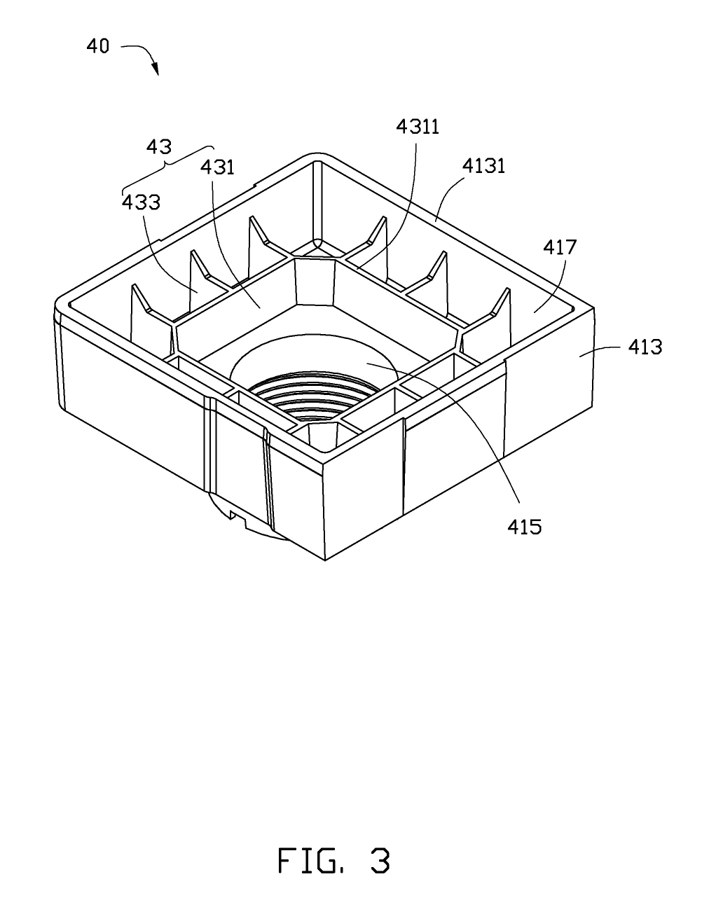

Referring also to FIG. 3, the lens holder 40 includes an outer sensor cover 41, an inner sensor cover 43, and a barrel coupler 45.

The outer sensor cover 41 is cuboid shaped with the bottom side open, and includes an upper wall 411 and a peripheral wall 413. A through hole 415 is defined in a center of the upper wall 411. The peripheral wall 413 extends from the edges of the upper wall 411, thus the peripheral wall 413 and the upper wall 411 cooperatively define a receiving cavity 417. The peripheral wall 413 includes an end surface 4131 away from the upper wall 411.

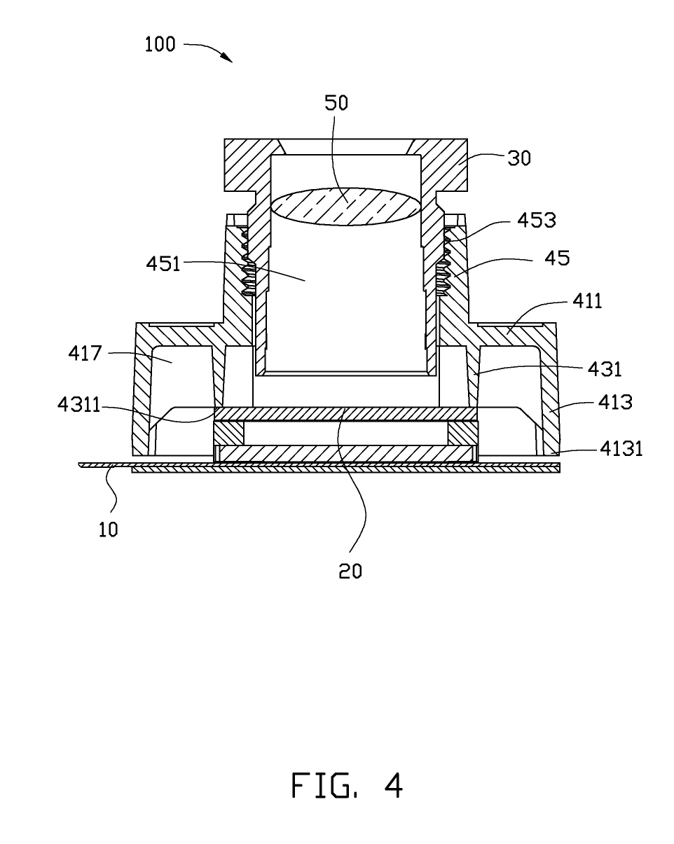

The inner sensor cover 43 is received in the receiving cavity 417 of the outer sensor cover 41. The inner sensor cover 43 includes a main body 431 and a plurality of ribs 433. The main body 431 is substantially a rectangular tube, extending upright from an inner side of the upper wall 411 of the outer sensor cover 41, and surrounding the through hole 415 of the outer sensor cover 41. The main body 431 corresponds to the image sensor 20, that is, the bottom opening of the main body 431 corresponds to the periphery of the image sensor 20 in shape and size (see FIG. 4). The main body 431 includes an end surface 4311 away from the upper wall 411. A distance from the end surface 4311 to the end surface 4131 is equal to or smaller than a height of the image sensor 20, such that there is no acting forces exerted between the outer sensor cover 41 and the PCB 10. The ribs 433 connect the main body 431 to the inner surface of the peripheral wall 413, for reinforcing a structural strength of the inner sensor cover 43.

The barrel coupler 45 is tubular, extending upward from the upper wall 411 and aligning with the periphery of the through hole 415. The barrel coupler 45 defines a receiving hole 451, communicating with the through hole 415. The barrel coupler 45 forms an internal threaded section 453 in an inner surface of the barrel coupler 45, engaging with the external threaded section 34 of the lens barrel 30.

The lens 50 is configured for optical imaging.

Referring also to FIG. 4, in assembly, first, the lens 50 is received in the lens barrel 30, the barrel hole 32 is sealed, and the image sensor 20 is fixed and electrically connected to the PCB 10. Second, the lens barrel 30 together with the lens 50 is inserted into the receiving hole 451 and is threadedly coupled to the lens holder 40 by the engagement of the outer threaded section 34 with the internal threaded section 453. At last, the lens holder 40 together with the lens barrel 30 is fixed to the image sensor 20 in such a way that the main body 431 of the inner sensor cover 43 is fixed to and resisting the periphery of the image sensor 20. In addition, the end surface 4131 of the peripheral wall 413 contacts the PCB 10 or adheres to the PCB 10 via adhesive.

In the illustrated embodiment, the main body 431 is fixed to the image sensor 20 and also resists the image sensor 20, such that the lens holder 40 avoids directly resisting the PCB 10; as a result, even though the high temperature causes the PCB 10 to deform, the stability of the lens holder 40 cannot be negatively affected. Because the contacting area between the main body 431 and the image sensor 20 is relatively small, it is easier to flatly connect the lens holder 40 to the image sensor 20.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera module, comprising:
a printed circuit board (PCB);
an image sensor positioned on the PCB;
a lens holder positioned on the PCB and covering the image sensor, wherein the lens holder comprises an outer sensor cover and an inner sensor cover connected to the outer sensor cover, the outer sensor cover defines a receiving cavity, the image sensor and the inner sensor cover are received in the receiving cavity, the inner sensor cover is fixed to and resists the image sensor, and the distance between the end surface of the outer sensor cover and the PCB is equal to or greater than zero;
a lens barrel coupled to the lens holder; and
a lens received in the lens barrel.

2. The camera module of claim 1, wherein the inner sensor cover comprises a main body extending from the outer sensor cover, and the main body is fixed to and resists the periphery of the image sensor.

3. The camera module of claim 2, wherein the inner sensor cover also comprises a plurality of ribs, and the ribs connect the main body to the outer sensor cover.

4. The camera module of claim 1, wherein the outer sensor cover comprises an upper wall and a peripheral wall extending from the edges of the upper wall, and the upper wall and the peripheral wall cooperatively define the receiving cavity.

5. The camera module of claim 4, wherein the lens holder also comprises a barrel coupler, the barrel coupler is threadedly coupled to the lens barrel, a through hole is defined in the upper wall, and the barrel coupler extends from the upper wall and aligns with the periphery of the through hole.

6. A camera module, comprising:
a printed circuit board (PCB);
an image sensor positioned on the PCB;
a lens holder positioned on the PCB and covering the image sensor, wherein the lens holder comprises an outer sensor cover, an inner sensor cover, and a barrel coupler, the outer sensor cover comprises an upper wall defining a through hole, the inner sensor cover extends from an inner side of the upper wall, and is fixed to and resists the image sensor, the barrel coupler extends from the upper wall and aligns with the periphery of the through hole, and the distance between the end surface of the outer sensor cover and the PCB is equal to or greater than zero;
a lens barrel coupled to the barrel coupler; and
a lens received in the lens barrel.

7. The camera module of claim 6, wherein the inner sensor cover comprises a main body extending from the upper wall surrounding the through hole, and the main body is fixed to and resists the periphery of the image sensor.

8. The camera module of claim 7, wherein the outer sensor cover also comprises a peripheral wall extending from the edges of the upper wall, the upper wall and the peripheral wall cooperatively define a receiving cavity, and the inner sensor cover and the image sensor are received in the receiving cavity.

9. The camera module of claim 8, wherein the inner sensor cover also comprises a plurality of ribs, the ribs connect the main body to the peripheral wall.

10. The camera module of claim 8, wherein the main body comprises an end surface away from the upper wall, the peripheral wall comprises an end surface away from the upper wall, a distance from the end surface of the main body to the end surface of the peripheral wall is equal to or smaller than a height of the image sensor.
